(19) United States
(12) Patent Application Publication
(10) Pub. No.: US 2003/0201024 A1
(43) Pub. Date: Oct. 30, 2003

(54) Radiator patch kit

(76) Inventor: Gerald King, Phoenix, AZ (US)

Correspondence Address: The Halvorson Law Firm, Ste. 1, 405 W. Southern Ave., Tempe, AZ, 85282, US

(21) Appl. No.: 10/134,096

(22) Filed: Apr. 26, 2002

(51) Int. Cl. F16L 55/16

(52) U.S. Cl. 138/99

(57) ABSTRACT

A kit for providing temporary radiator repair comprising at least one laminate patch and at least one radiator clamp capable of forcibly holding the composite patch to tank portions, such as on the top or sides of the radiator, and at least one load distribution bar for more even distributing the compression force on the top of the radiator.

### FIELD OF THE INVENTION

The present invention generally relates to a kit for patching holes or cracks in radiators. More specifically, the present invention relates to a temporary radiator patch kit.

### BACKGROUND OF THE INVENTION

Currently automobile radiators are increasingly made as composite devices. The main heat exchange is made from a metallic material. However, the top of the radiator, once a metallic material, is now a plastic or polymeric material. Because of the properties inherent in plastic or polymeric materials, any holes or cracks that develop in the top cannot be fixed using methods common in the industry (welding or soldering). Thus, there is a clear and present need to provide a patch kit that is able to repair holes or cracks in the tops of modern radiators.

### SUMMARY OF THE INVENTION

It is an object of the present invention to provide a kit that is capable of patching or repairing cracks or holes in modern radiators.

It is another object of the present invention to provide a radiator patch kit that comprises at least one laminate patch and at least one radiator clamp capable of forcibly holding the composite patch to tank portions of the radiator.

It is still another object of the present invention to provide a radiator patch kit that comprises at least one laminate patch and at least one radiator clamp capable of forcibly holding the composite patch to tank portions of the radiator and at least one load distribution bar for more evenly distribution the compression force on the tank portion of the radiator.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. § 112, paragraph 6 to define the invention. To the contrary, if the provisions of 35 U.S.C. § 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. § 112, paragraph 6. Moreover, even if the provisions of 35 U.S.C. § 112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 illustrates an exploded view of the patch kit according to the present invention.

FIG. 2 illustrates the patch kit of the present invention attached to a radiator.

FIG. 3 illustrates the patch kit of the present invention used without using the load distribution bars.

FIG. 3A illustrates the patch kit of the present invention used using the load distribution bars.

FIGS. 4A through 4D illustrates steps used when attaching the patch kit of the present invention to a radiator.

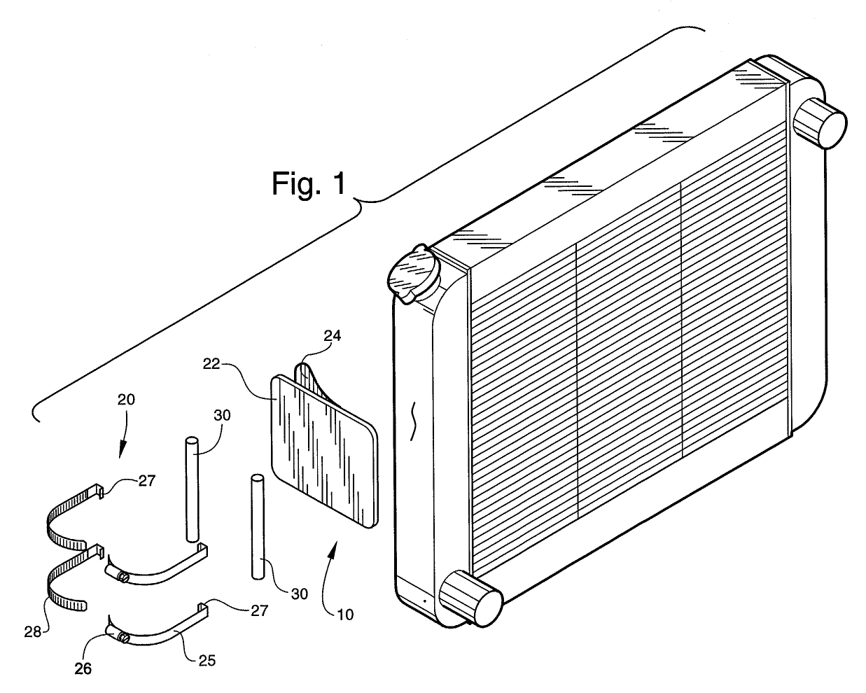

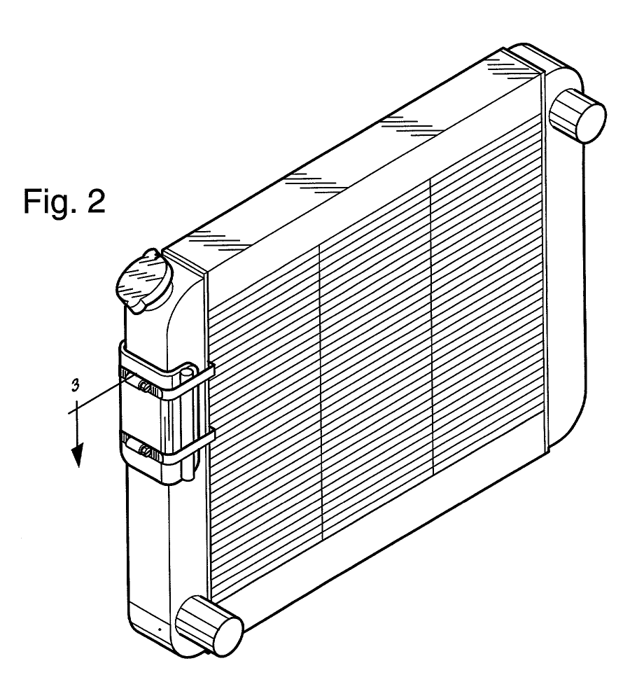

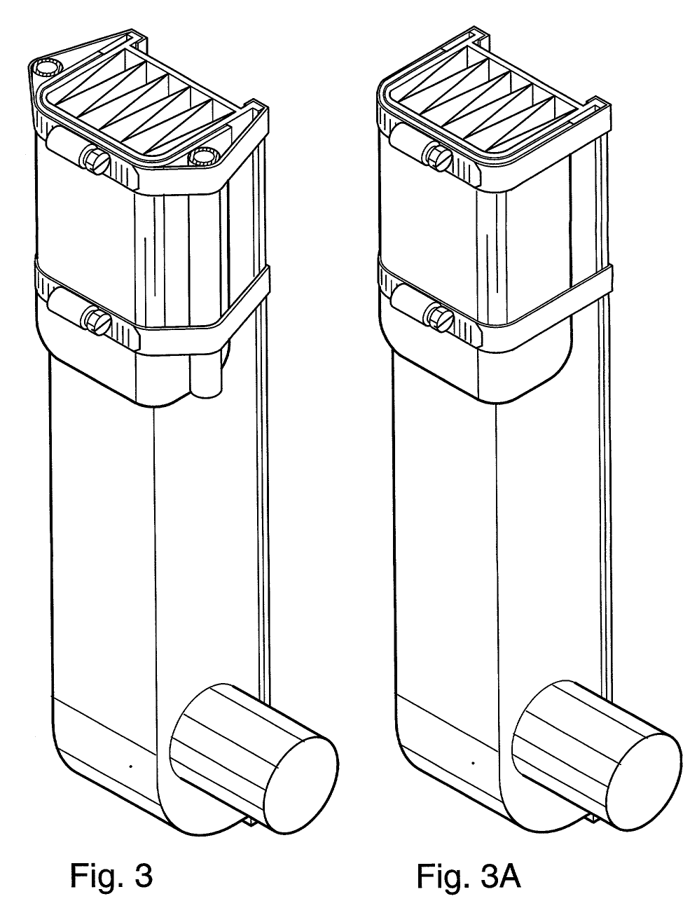

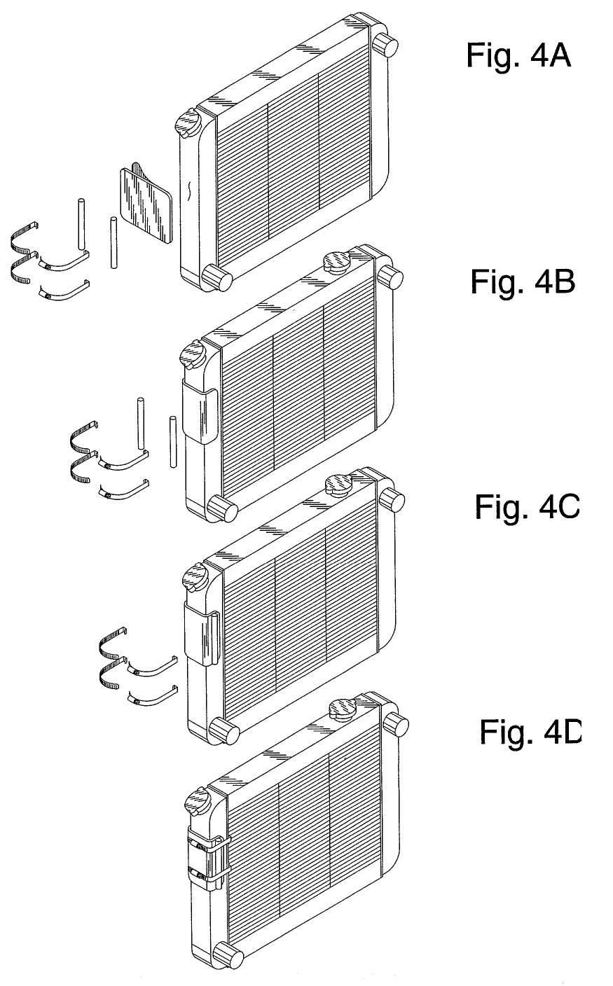

### DESCRIPTION OF PREFERRED EMBODIMENTS OF THE INVENTION

The present invention is a kit that is useful for temporarily patching cracks or holes in tank portions, such as located on the top or sides of modern radiators.

The kit of the present invention preferably comprises at least one laminate patch 10 and at least one radiator clamp 20 capable of forcibly holding the composite patch to the top of the radiator and at least one load distribution bar 30 for more even distributing the compression force on the top of the radiator.

Each of the at least one laminate patches 10 is preferably a two component laminate with a top layer 22 being a hard pressure distributing material, preferably a metallic material such as aluminum, copper or the like. However, other hard pressure distributing materials, such as hard plastics may be used as the top layer 22 and still fall within the scope of the present invention. There is a bottom layer 24 that is preferably a material that is softer than the top layer 22 and is preferably effectively deformable under compression. In the preferred embodiment, the top layer 22 is attached to the bottom layer 24 by an adhesive layer or other attachment means. The laminate patch 10 is preferably bendable and, once bent, retains the bent shape. That is to say, it is preferred that the laminate patch 10 have no effective shape memory. This allows the laminate patch 10 to be formed around differently sized and shaped radiator tops.

Included in the kit according to the present invention is at least one open ended radiator clamp 20 capable of forcibly holding the composite patch to the top of the radiator. Each radiator clamp 20 is preferably comprised of two sections 25 that are moveably coupled using a tightening mechanism 26, preferably a worm gear. At distal ends of each of the two sections 25 are hooks 27. It is important to note that the tightening mechanism brings proximate ends of the two sections 25 together and leaves the distal ends free to be attached to a lip on a radiator. Thus, the radiator clamps 20 according to the present invention are open-ended claims that do not form a closed loop by themselves.

Also included in the kit according to the present invention are at least one load distribution bar 30 for more evenly distributing the compression force on the top of the radiator. Preferably, each load distribution bar 30 is a simple cylinder of hard material, such as a metal, wood, or the like. Other shapes for the load distribution bars 30 may be used and still fall within the scope of the present invention.

In use, the laminate patch 10 is placed over the crack or hole in the radiator top. At least one, preferably two, radiator claims are placed over the laminate patch 10, where each hook 27 on the distal ends of the two section 25 are located to opposite positions underneath a lip formed by the radiator tank and the radiator top. The tightening mechanism 27 is tightened, thereby forcing the two sections 25 together and applying and maintaining pressure onto the laminate patch 10. It is this pressure that compresses the second layer 14 of the laminate patch 10 into, around, and/or over the hole or crack, effectively sealing the hole or crack until such time a more permanent repair may be made.

In some instances, the compression force generated by the radiator clamps 20 needs to be more evenly distributed. In these instances, one, or more, of the load distribution bars 30 may be placed between the laminate patch 10 and the radiator clamps 20 (in these instances, while one radiator clamp 20 may be used, it is preferred that two or more be used in order to generate a large even compression force). The load distribution bar(s) 30 allows the compression force generate by each radiator clamp 20 used to be spread along the entire length of the load distribution bar(s) 30.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A kit for providing temporary radiator repair comprising at least one laminate patch and at least one opened ended radiator clamp.

2. The kit according to claim 1 further comprising at least one load distribution bar.

3. The kit according to claim 1 wherein the at least one radiator clamp comprises two sections coupled together with a tightening mechanism.

4. The kit according to claim 2 wherein the at least one open ended radiator clamp comprises two sections coupled together with a tightening mechanism.

5. The kit according to claim 3 wherein the two section of the at least one open ended radiator clamps each have a hook at distal ends of each section.

6. The kit according to claim 4 wherein the two section of the at least one opene ended radiator clamps each have a hook at distal ends of each section.

7. The kit according to claim 5 wherein the tightening mechanism is a worm gear mechanism.

8. The kit according to claim 6 wherein the tightening mechanism is a worm gear mechanism.
